(19) United States
(12) Patent Application Publication
(10) Pub. No.: US 2010/0246868 A1
(43) Pub. Date: Sep. 30, 2010

(54) METHOD FOR OPERATING A HEARING APPARATUS WITH AMPLIFIED FEEDBACK COMPENSATION AND HEARING APPARATUS

(75) Inventor: Ulrich Kornagel, Erlangen (DE)

Correspondence Address: LERNER GREENBERG STEMER LLP, P O BOX 2480, HOLLYWOOD, FL, 33022-2480, US

(73) Assignee: SIEMENS MEDICAL INSTRUMENTS PTE. LTD., Singapore (SG)

(21) Appl. No.: 12/727,485

(22) Filed: Mar. 19, 2010

(30) Foreign Application Priority Data
Mar. 24, 2009 (DE) 10 2009 014 540.0

(51) Int. Cl. H04R 25/00

(52) U.S. Cl. 381/318

(57) ABSTRACT

The goal is to make insertion of a hearing apparatus in an ear more comfortable, in particular with respect to feedback whistling. A method for operating a hearing apparatus by amplifying an input sound to form an output sound and compensating by a predefined amount for feedback caused by the output sound is therefore provided. In a predetermined period after switching on the hearing apparatus, the amount of feedback compensation is automatically increased by an offset greater than zero compared with the predefined amount. By way of example, amplified feedback, which is caused by a hand when inserting the hearing apparatus or hearing aid into the ear, can be better compensated thereby. Feedback whistling when inserting a hearing aid for example can thus be avoided.

### CROSS-REFERENCE TO RELATED APPLICATION

This application claims the priority, under 35 U.S.C. §119, of German application DE 10 2009 014 540.0, filed Mar. 24, 2009; the prior application is herewith incorporated by reference in its entirety.

### BACKGROUND OF THE INVENTION

### Field of the Invention

The present invention relates to a method for operating a hearing apparatus by amplifying an input sound to form an output sound and compensating by a predefined amount for feedback caused by the output sound. The present invention also relates to a hearing apparatus containing an amplification device for amplifying an input sound to form an output sound and a feedback compensation device for compensating by a predefined amount for feedback caused by the output sound. The term ‘hearing apparatus’ is in this case taken to mean any sound-emitting device that can be worn on the ear or head, in particular a hearing aid, headset, headphones or the like.

Hearing aids are wearable hearing apparatus that are used to support the hard of hearing. Different hearing aid designs, such as behind-the-ear hearing aids (BTE), hearing aids with an external receiver (RIC: receiver in the canal) and in-the-ear hearing aids (ITE), for example also concha hearing aids or completely-in-canal hearing aids (ITE, CIC) are provided in order to accommodate the numerous individual requirements. The hearing aids listed by way of example are worn on the outer ear or in the auditory canal. However, bone conduction hearing aids, implantable or vibrotactile hearing aids are also commercially available, moreover. In this case damaged hearing is either mechanically or electrically stimulated.

In principle hearing aids have as their fundamental components an input converter, an amplifier and an output converter. The input converter is usually a sound pick-up, for example a microphone and/or an electromagnetic receiver, for example an induction coil. The output converter is usually implemented as an electroacoustic converter, for example a miniature loudspeaker, or as an electromechanical converter, for example a bone conduction receiver. The amplifier is conventionally integrated in a signal processing unit. This basic construction is shown in FIG. 1 using the example of a behind-the-ear hearing aid. One or more microphone(s) 2 for receiving the sound from the environment are fitted in a hearing aid case 1 for wearing behind the ear. A signal processing unit 3, which is also integrated in the hearing aid case 1, processes the microphone signals and amplifies them. The output signal of the signal processing unit 3 is transmitted to a loudspeaker or receiver 4 which outputs an acoustic signal. The sound is optionally transmitted via a sound tube, which is fixed to an otoplastic in the auditory canal, to the eardrum of the wearer of the aid. The energy supply to the hearing aid, and in particular that of the signal processing unit 3, takes place by way of a battery 5 likewise integrated in the hearing aid case 1.

If a hearing aid is to be used it is usually first switched on and then inserted in the ear. The feedback conditions of the hearing aid change due to hands on the hearing aid or ear. The degree of feedback is usually increased by the hands. Feedback whistling therefore often occurs as the hearing aid is being inserted, according to the adjusted or selected amplification of the hearing aid.

Previously this problem of feedback whistling on insertion has been solved by the hearing aid being muted for a certain time following the switching-on process. This time should be long enough for the insertion process to generally be complete before the hearing aid is finally activated. A drawback of this temporary muting is that during the insertion process the hearing aid wearer does not receive the response as to whether he has indeed correctly activated the hearing aid or inserted it correctly. A common consequence of this is manual readjustment of the hearing aid in the assumption that it will be possible to eliminate the supposed error. Feedback whistling can therefore occur again at the instant of complete activation of the hearing aid.

In a modification of the above solution a signal (a melody for example) generated in the hearing aid is output during the muted period. This provides the hearing aid wearer with a definite indication of the hearing aid having been activated. This manner of playing back an artificial signal is frequently rejected by hearing aid wearers, however.

### SUMMARY OF THE INVENTION

It is accordingly an object of the invention to provide a method for operating a hearing apparatus with amplified feedback compensation and a hearing apparatus which overcome the above-mentioned disadvantages of the prior art methods and devices of this general type, which makes the process of attaching a hearing apparatus to an ear more comfortable with respect to feedback artifacts.

According to the invention the object is achieved by a method for operating a hearing apparatus by amplifying an input sound to form an output sound and compensating by a predefined amount the feedback caused by the output sound. In a predetermined period after switching on the hearing apparatus, the amount of feedback compensation is automatically increased by an offset greater than zero compared with the predefined amount.

Furthermore, according to the invention a hearing apparatus is provided, and contains an amplification device for amplifying an input sound to form an output sound and a feedback compensation device for compensating by a predefined amount for feedback caused by the output sound. Wherein in a predetermined period after switching on the hearing apparatus, the amount of feedback compensation is automatically increased by the feedback compensation device by an offset greater than zero compared with the predefined amount.

The feedback when switching on the hearing apparatus is therefore advantageously also reduced or (completely or partially) compensated in accordance with the offset. This additional reduction in feedback artifacts means, for example, that feedback whistling can be avoided for a predicted time required to insert a hearing aid into an ear.

The predefined amount of feedback compensation is preferably a maximum value set for normal operation of the hearing apparatus. Therefore a maximum value for feedback compensation is set for normal operation of the hearing aid, at which value the disruptive artifacts are still just about acceptable. The maximum value can be exceeded by the offset for the insertion phase, because in this phase the artifacts caused by the compensation algorithm will be less disruptive than the feedback whistling.

The offset can be constant for a predetermined period. This is advantageous if a hand provokes consistently high feedback throughout the entire phase of attaching the hearing apparatus in or on the ear.

According to an alternative embodiment the offset can also decrease from an initial value to zero for the predetermined period. As a result no sudden transitions to normal operation occur at the end of the hearing aid attachment phase.

The predetermined period in which compensation is also increased after switching-on can be individually adjusted in the hearing apparatus for a user, moreover. The time which an individual user needs to attach the hearing apparatus or hearing aid can therefore be individually taken into account.

The profile over time of the offset in the hearing apparatus can also be selected from a plurality of profiles. The user or hearing aid wearer can also independently decide afterwards how long and in what manner he wants to use the additional compensation of feedback after switching on as a result of this as well.

Other features which are considered as characteristic for the invention are set forth in the appended claims.

Although the invention is illustrated and described herein as embodied in a method for operating a hearing apparatus with amplified feedback compensation and a hearing apparatus, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE SEVERAL VIEWS OF THE DRAWING

FIG. 1 is an illustration of a basic construction of a hearing aid according to the prior art;

FIG. 2 is a graph showing a profile over time of an offset for feedback compensation; and

FIG. 3 is a graph showing a different profile over time of the offset for feedback compensation.

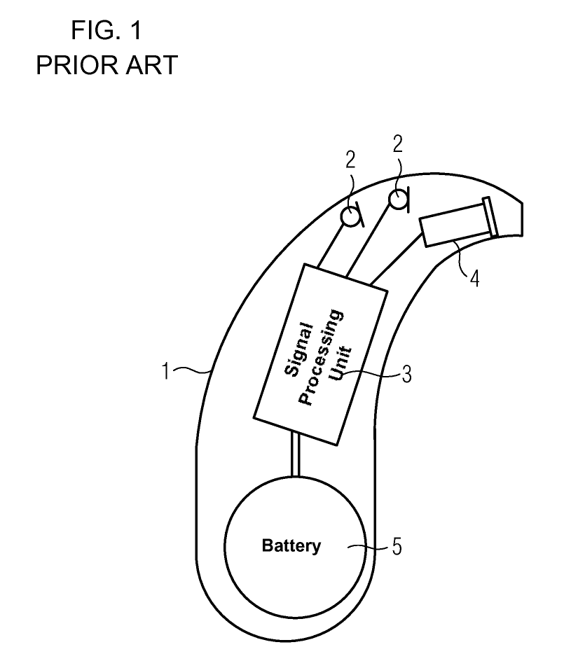

### DETAILED DESCRIPTION OF THE INVENTION

The exemplary embodiments described in more detail hereinafter are preferred embodiments of the present invention. They refer to the insertion of a hearing aid in an ear or the attachment of a hearing aid to an ear.

Amplification of the hearing aid can be adjusted to be so high that the system is close to the stability limit above which the hearing aid starts to whistle. A hand on the hearing aid is then enough, for example, to increase the intensity of the feedback such that the stability limit is exceeded. When inserting the hearing aid into the ear or attaching it to the ear it is necessary for the hand to be on the hearing aid or in the vicinity thereof for a certain amount of time, however. According to the invention it is therefore proposed that a feedback compensator, which reduces (completely or partially compensates) the effects of feedback, is switched to a particularly high level of effectiveness during the predicted time required to insert the hearing aid into the ear.

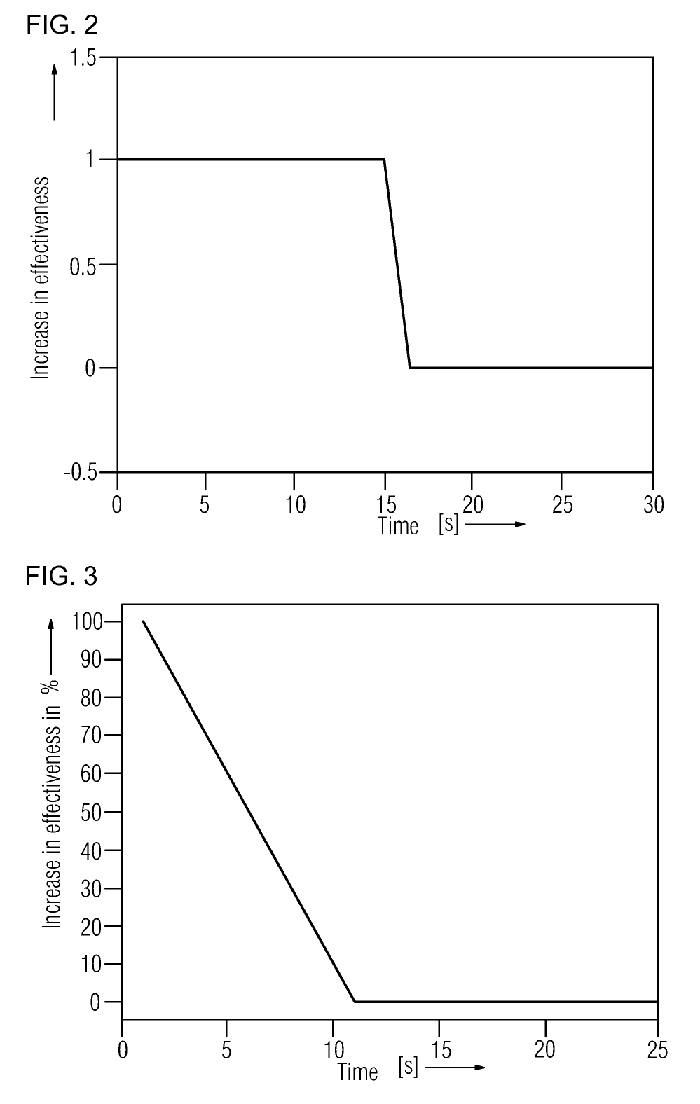

Referring now to the figures of the drawing in detail and first, particularly, to FIG. 2 thereof, there is shown a specific example in this respect. This shows the increase in effectiveness of a feedback compensator or feedback compensation device with its profile over time. During normal operation the feedback compensation algorithm operates with a predefined level of effectiveness. Therefore the feedback effect is reduced by a certain amount, i.e. completely or partially. This predefined effectiveness of the feedback compensation algorithm can be an initial effectiveness during switching-on or, for example, a maximum effectiveness. As already mentioned, the maximum effectiveness is set by the fact that it constitutes a limit below which the artifacts of feedback compensation are still just about acceptable to the hearing aid wearer. This initial or maximum value of effectiveness of feedback compensation is shown in the right-hand part of FIG. 2. The increase in effectiveness during this normal operation is zero by definition. In the examples of FIG. 2 normal operation starts after approximately 15 seconds. Prior to this, in the switch-on phase, i.e. from zero to 15 seconds, the effectiveness is increased by an offset.

In the present example the effectiveness is increased by an amount of one at most. The increase, i.e. the offset in effectiveness, stays the same throughout the entire switch-on time. At the end of the switch-on phase the increase in effectiveness suddenly or very quickly returns to zero. Therefore the effectiveness of the feedback compensation algorithm is no longer increased compared with the normal operation phase: the normal operating phase begins.

The extent of the offset during the switch-on phase can be predefined or be selected by the hearing aid wearer within certain limits. The switch-on phase can also be predetermined or be variable for the hearing aid wearer. The hearing aid wearer will conventionally select the switch-on phase to be as short as possible in order that he is disturbed by artifacts, which the increase in the effectiveness of the feedback compensation algorithm entails, for as short a time as possible.

The quick or sudden reduction in the increase in effectiveness of the feedback compensation algorithm following the switch-on phase can itself lead to problems or artifacts. It is therefore sometimes advantageous if, according to the example of FIG. 3, the increase in the effectiveness of the compensation algorithm is gradually reduced during the switch-on phase. In the specific example the effectiveness starts with a 100% increase during the switching-on process and is then linearly reduced to a zero percent increase. The time for this reducing process is based on the anticipated length of time for insertion of the hearing aid in this case as well. Of course other functions may also be selected to reduce the increase, i.e. to reduce the offset in effectiveness of the feedback compensation algorithm to zero. Constant functions without hops are preferred in this regard.

A particularly advantageous feature of the increase in effectiveness of the feedback compensation device during the switch-on phase is that feedback whistling is effectively suppressed even in the case of very pronounced feedback paths, as occur during insertion of the hearing aid. Furthermore, the hearing aid wearer immediately perceives whether he has correctly activated the hearing aid as he receives output sound signals from his hearing aid as early as during insertion. He can also acoustically sense his environment immediately after inserting the hearing aid, i.e. as early as in the switch-on phase of the hearing aid, even if the particularly high effectiveness of the feedback compensator possibly causes new artifacts, although these are short-lived.

1. A method for operating a hearing apparatus, which comprises the steps of:
amplifying an input sound to form an output sound;
compensating by a predefined amount for feedback caused by the output sound; and
automatically increasing an amount of feedback compensation by an offset greater than zero compared with the predefined amount during a predetermined period after switching on the hearing apparatus.

2. The method according to claim 1, wherein the predefined amount of compensation is a maximum value set for normal operation of the hearing apparatus.

3. The method according to claim 1, which comprises setting the offset to be constant for the predetermined period.

4. The method according to claim 1, which further comprising decreasing the offset from an initial value to zero during the predetermined period.

5. A hearing apparatus, comprising:
an amplification device for amplifying an input sound to form an output sound; and
a feedback compensation device for compensating by a predefined amount for feedback caused by the output sound, and in a predetermined period after switching on the hearing apparatus, an amount of feedback compensation is automatically increased by said feedback compensation device by an offset greater than zero compared with the predefined amount.

6. The hearing apparatus according to claim 5, wherein the predefined amount of compensation is a maximum value set during operation of the hearing apparatus.

7. The hearing apparatus according to claim 5, wherein the predetermined period can be individually adjusted in the hearing apparatus for a user.

8. The hearing apparatus according to claim 5, wherein a profile over time of the offset in the hearing apparatus can be selected from a plurality of profiles.

9. The hearing apparatus according to claim 5, wherein the offset is constant for the predetermined period.

10. The hearing apparatus according to claim 5, wherein the offset decreases from an initial value to zero for the predetermined period.
